(19) United States
(12) Patent Application Publication
(10) Pub. No.: US 2005/0245427 A1
(43) Pub. Date: Nov. 3, 2005

(54) Use of compolymer containing alkylene oxide units, as an additive in detergents and cleansers

(75) Inventors: Pia Baum, Weinheim (DE); Kathrin Michl, Ludwigshafen (DE); Franz Weingart, Weinheim (DE); Stephan Nied, Neustadt/Wstr (DE); Gregor Brodt, Heppenheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/516,201

(22) PCT Filed: Jun. 4, 2003
(86) PCT No.: PCT/EP03/05823

§ 371 Date: Nov. 30, 2004

(30) Foreign Application Priority Data
Jun. 7, 2002 (DE) 102 25 594.6

(51) Int. Cl. C11D 3/37

(52) U.S. Cl. 510/475

(57) ABSTRACT

Use of copolymers containing alkylene oxide units which comprise (a) 50 to 93 mol % of acrylic acid and/or a water-soluble salt of acrylic acid, (b) 5 to 30 mol % of methacrylic acid and/or a water-soluble salt of methacrylic acid and
(c) 2 to 20 mol % of at least one nonionic monomer of formula I 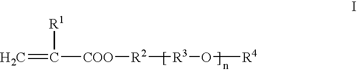 in which the variables have the following meanings:
R¹ is hydrogen or methyl;
R² is a chemical bond or unbranched or branched C₁-C₆-alkylene;
R³ are identical or different unbranched or branched C₂-C₄-alkylene radicals;
R⁴ is unbranched or branched C₁-C₆-alkyl; n is 3 to 50, in random or block copolymerized form, as additive for detergents and cleaners.

The present invention relates to the-use of copolymers containing alkylene oxide units which comprise
(a) 50 to 93 mol % of acrylic acid and/or a water-soluble salt of acrylic acid,
(b) 5 to 30 mol % of methacrylic acid and/or a water-soluble salt of methacrylic acid
   and
(c) 2 to 20 mol % of at least one nonionic monomer of formula I 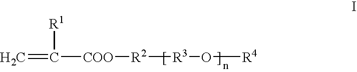
   in which the variables have the following meanings:
   R¹ is hydrogen or methyl;
   R² is a chemical bond or unbranched or branched C₁-C₆-alkylene;
   R³ are identical or different unbranched or branched C₂-C₄-alkylene radicals;
   R⁴ is unbranched or branched C₁-C₆-alkyl;
   n is 3 to 50,
      in random or block copolymerized form, as additive for detergents and cleaners.

The invention further relates to detergents and cleaners which comprise these copolymers as deposit-inhibiting additive.

In the case of machine dishwashing, the ware should be obtained in a residue-free cleaned state with a flawlessly gleaming surface, for which a detergent, a rinse aid and regenerating salt for water softening usually have to be used.

The “2 in 1” dishwashing detergents on the market comprise, in addition to the detergent for removing the soilings on the ware, integrated clear-rinse surfactants which, during the clear-rinse and drying operation, ensure flat water run-off on the ware, thus preventing lime and water marks. The topping-up of a rinse aid is no longer required with the use of these products.

Modern machine dishwashing detergents, “3 in 1” detergents, are intended to combine the three functions of the detergent, the rinse aid and the water softening in a single detergent formulation, meaning that the topping-up of salt for water hardnesses from 1 to 3 also becomes superfluous for the consumer. To bind the hardness-forming calcium and magnesium ions, sodium tripolyphosphate is usually added to these detergents. However, these in turn result in calcium and magnesium phosphate deposits on the ware.

EP-A-324 568 describes water-soluble copolymers for detergents and cleaners which are obtained by polymerization of acrylic acid, methacrylic acid and alkoxypolyethylene glycol methacrylates which have a long-chain alkoxy radical and/or a long-chain polyethylene glycol block in the presence of isopropanol. The alkoxypolyethylene glycol methacrylate fraction of these copolymers is <1 mol %.

According to JP-A-1991/185184, it is possible to use copolymers based on at least one monomer from the group consisting of maleic acid, acrylic acid and methacrylic acid and an optionally methoxy- or ethoxylated polyethylene glycol (meth)acrylate as further monomer, which have an average molecular weight M_{w} of from 1 000 to 10 000, for the desizing, cleaning, bleaching and dyeing of natural and synthetic fibers. Specifically disclosed are copolymers of acrylic acid and methoxypolyethylene glycol methacrylate.

JP-A-2000/24691 describes copolymers of unsaturated carboxylic acids and monomers containing polyalkylene oxide units with average molecular weights M_{w} of >50 000 to 3 000 000 as agents against scale, based in particular on silicates., in water cycles, e.g. cooling systems. Specifically disclosed are again only copolymers of acrylic acid and methoxypolyethylene glycol methacrylate.

It is an object of the present invention to remedy the problems described above and to provide an additive which can be used advantageously especially in multifunctional cleaners and at the same time, in particular, exhibits a deposit-inhibiting action.

We have found that this object is achieved by the use of copolymers containing alkylene oxide units which comprise
(a) 50 to 93 mol % of acrylic acid and/or a water-soluble salt of acrylic acid,
(b) 5 to 30 mol % of methacrylic acid and/or a water-soluble salt of methacrylic acid
   and
(c) 2 to 20 mol % of at least one nonionic monomer of formula I 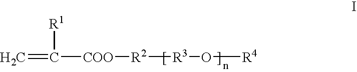
   in which the variables have the following meanings:
R¹ is hydrogen or methyl;
R² is a chemical bond or unbranched or branched C₁-C₆-alkylene;
R³ are identical or different unbranched or branched C₂-C₄-alkylene radicals;
R⁴ is unbranched or branched C₁-C₆-alkyl;
n is 3 to 50,
   in random or block copolymerized form, as additive for detergents and cleaners.

We have also found detergents and cleaners which comprise the copolymers containing alkylene oxide units as deposit-inhibiting additive.

The copolymers containing alkylene oxide units comprise, as copolymerized components (a) and (b), acrylic acid or methacrylic acid and/or water-soluble salts of these acids, in particular the alkali metal salts, such as potassium and primarily sodium salts, and ammonium salts.

The proportion of acrylic acid (a) in the copolymers to be used according to the invention is 50 to 93 mol %, preferably 65 to 85 mol % and particularly preferably 65 to 75 mol %.

Methacrylic acid (b) is present in the copolymers to be used according to the invention in an amount of from 5 to 30 mol %, preferably in an amount of from 10 to 25 mol % and especially in an amount of from 15 to 25 mol %.

The copolymers comprise, as component (c), nonionic monomers of the formula I 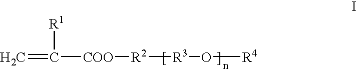
in which the variables have the following meanings:
R¹ is hydrogen or preferably methyl;
R² is unbranched or branched C₁-C₆-alkylene or preferably a chemical bond;
R³ is identical or different unbranched or branched C₂-C₄-alkylene radicals, primarily C₂-C₃-alkylene radicals, in particular ethylene;
R⁴ is unbranched or branched C₁-C₆-alkyl, preferably C₁-C₂-alkyl;
n is 3 to 50, preferably 5 to 40, particularly preferably 10 to 30.

Particularly suitable examples of the monomers II which may be mentioned are: methoxypolyethylene glycol(meth)acrylate, methoxypolypropylene glycol(meth)acrylate, methoxypolybutylene glycol(meth)acrylate, methoxypoly(propylene oxide-co-ethylene oxide)(meth)acrylate, ethoxypolyethylene glycol(meth)acrylate, ethoxypolypropylene glycol(meth)acrylate, ethoxypolybutylene glycol(meth)acrylate and ethoxypoly(propylene oxide-co-ethylene oxide)(meth)acrylate, where methoxypolyethylene glycol(meth)acrylate and methoxypolypropylene glycol(meth)acrylate are preferred and methoxypolyethylene glycol methacrylate is particularly preferred.

The polyalkylene glycols contain here 3 to 50, in particular 5 to 40 and especially 10 to 30, alkylene oxide units.

The proportion of the nonionic monomers (c) in the copolymers to be used according to the invention is 2 to 20 mol %, preferably 5 to 15 mol % and especially 5 to 10 mol %.

The copolymers to be used according to the invention usually have an average molecular weight M_{w} of from 3 000 to 50 000, preferably from 10 000 to 30 000 and particularly preferably from 15 000 to 25 000.

The K value of the copolymers is usually 15 to 40, in particular 20 to 35, especially 27 to 30 (measured in 1% strength by weight aqueous solution at 25° C., in accordance with H. Fikentscher, Cellulose-Chemie, vol. 13, pp. 58-64 and 71-74 (1932)).

The copolymers to be used according to the invention can be prepared by free radical polymerization of the monomers. In this connection, it is possible to work in accordance with any known free radical polymerization process. In addition to bulk polymerization, mention may be made in particular of the processes of solution polymerization and emulsion polymerization, preference being given to solution polymerization.

The polymerization is preferably carried out in water as solvent. It can, however, also be carried out in alcoholic solvents, in particular C₁-C₄-alcohols, such as methanol, ethanol and isopropanol, or mixtures of these solvents with water.

Suitable polymerization initiators are compounds which either decompose thermally or photochemically (photoinitiators) to form free radicals.

Of the thermally activatable polymerization initiators, preference is given to initiators with a decomposition temperature in the range from 20 to 180° C., in particular from 50 to 90° C. Examples of suitable thermal initiators are inorganic peroxo compounds, such as peroxodisulfates (ammonium and preferably sodium peroxodisulfate), peroxosulfates, percarbonates and hydrogen peroxide; organic peroxo compounds, such as diacetyl peroxide, di-tert-butyl peroxide, diamyl peroxide, dioctanoyl peroxide, didecanoyl peroxide, dilauroyl peroxide, dibenzoyl peroxide, bis(o-tolyl)peroxide, succinyl peroxide, tert-butyl peracetate, tert-butyl permaleate, tert-butyl perisobutyrate, tert-butyl perpivalate, tert-butyl peroctoate, tert-butyl perneodecanoate, tert-butyl perbenzoate, tert-butyl peroxide, tert-butyl hydroperoxide, cumene hydroperoxide, tert-butyl peroxy-2-ethylhexanoate and diisopropyl peroxydicarbamate; azo compounds, such as 2,2′-azobisisobutyronitrile, 2,2′-azobis(2-methylbutyronitrile) and azobis(2-amidopropane)dihydrochloride.

These initiators can be used in combination with reducing compounds as starter/regulator systems. Examples of such reducing compounds which may be mentioned are phosphorus-containing compounds, such as phosphorus acid, hypophosphites and phosphinates, sulfur-containing compounds, such as sodium hydrogen sulfite, sodium sulfite and sodium formaldehyde sulfoxylate, and hydrazine.

Examples of suitable photoinitiators are benzophenone, acetophenone, benzoin ether, benzyl dialkyl ketones and derivatives thereof.

Preferably, thermal initiators are used, preference being given to inorganic peroxo compounds, in particular sodium peroxodisulfate (sodium persulfate). It is particularly advantageous to use the peroxo compounds in combination with sulfur-containing reducing agents, in particular sodium hydrogensulfite, as redox initiator system. If this starter/regulator system is used, copolymers are obtained which contain —SO₃⁻Na⁺ and/or —SO₄⁻Na⁺ as end groups and are characterized by particular cleaning power and deposit-inhibiting action.

Alternatively, it is also possible to use phosphorus-containing starter/regulator systems, e.g. hypophosphites/phosphinates.

The amounts of photoinitiator and/or starter/regulator system are to be matched to the substances used in each case. If, for example, the preferred system of peroxodisulfate/hydrogensulfite is used, then usually 2 to 6% by weight, preferably 3 to 5% by weight, of peroxodisulfate and usually 5 to 30% by weight, preferably 5 to 10% by weight, of hydrogensulfate, are used, in each case based on the monomers (a), (b) and (c).

If desired, it is also possible to use polymerization regulators. Suitable compounds are those known to the person skilled in the art, e.g. sulfur compounds, such as mercaptoethanol, 2-ethylhexyl thioglycolate, thioglycolic acid and dodecyl mercaptan. If polymerization regulators are used, their use amount is usually 0.1 to 15% by weight, preferably 0.1 to 5% by weight and particularly preferably 0.1 to 2.5% by weight, based on the monomers (a), (b) and (c).

The polymerization temperature is usually 30 to 200° C., preferably 50 to 150° C. and particularly preferably 80 to 120° C.

The polymerization can be carried out under atmospheric pressure, although it is preferably carried out in a closed system under the autogenous pressure which develops.

During the preparation of the copolymers to be used according to the invention, the monomers (a), (b) and (c) can be used as they are, although it is also possible to use reaction mixtures which are produced during the preparation of the monomers (c). Thus, for example, instead of methoxypolyethylene glycol methacrylate, the monomer mixture which forms during the esterification of polyethylene glycol monomethyl ether with an excess of methacrylic acid can be used. Advantageously, the esterification can also be carried out in situ in the polymerization mixture by combining (1) acrylic acid, (2) a mixture of methacrylic acid and polyethylene glycol monomethyl ether and (3) free radical starters in parallel. Where appropriate, a catalyst necessary for the esterification, such as methanesulfonic acid or p-toluenesulfonic acid can additionally be used here.

The copolymers to be used according to the invention can also be prepared by polymer-analogous reaction, e.g. by reaction of an acrylic acid/methacrylic acid copolymer with polyalkylene glycol monoalkyl ether. Preference is, however, given to free radical copolymerization of the monomers.

If desired for the application, the aqueous solutions produced during the preparation of the carboxylic acid group-containing copolymers to be used according to the invention can be neutralized or partially neutralized by adding base, in particular sodium hydroxide solution, i.e. be adjusted to a pH in the range from 4-8, preferably 4.5-7.5.

The copolymers used according to the invention are highly suitable as additive for detergents and cleaners.

They can particularly advantageously be used in machine dishwashing detergents. They are characterized primarily by their deposit-inhibiting action both toward inorganic and also organic deposits. In particular, deposits which are caused by the other constituents of the cleaning formulation, such as deposits of calcium and magnesium phosphate, calcium and magnesium silicate and calcium and magnesium phosphonate, and deposits which originate from the soil constituents of the wash liquor, such as fat, protein and starch deposits should be mentioned. The copolymers used according to the invention thereby also increase the cleaning power of the dishwashing detergent. In addition, even in low concentrations, they favor run-off of the water from the ware, meaning that the amount of rinse-aid surfactants in the dishwashing detergent can be reduced. If the sulfonic acid group-containing copolymers are used, particularly clear glassware and gleaming metal cutlery items are obtained, particularly when the dishwasher is operated without regenerating salt to soften the water. The sulfonic acid group-containing copolymers can therefore be used not only in 2 in 1 detergents, but also in 3 in 1 detergents.

The copolymers used according to the invention can be used directly in the form of the aqueous solutions produced during the preparation, and also in dried form obtained, for example, by spray drying, fluidized spray drying, drum drying or freeze drying. The detergents and cleaners according to the invention can correspondingly be prepared in solid or in liquid form, e.g. as powders, granulates, extrudates, tablets, liquids or gels.

### EXAMPLES

A) Preparation of Copolymers Containing Alkylene Oxide Units

### Example 1

In a reactor fitted with nitrogen inlet, reflux condenser and metering device, a mixture of 619 g of distilled water and 2.2 g of phosphorus acid was heated to an internal temperature of 100° C. with the introduction of nitrogen and stirring. Then, in parallel, (1) a mixture of 123.3 g of acrylic acid and 368.5 g of distilled water, (2) a mixture of 18.4 g of sodium peroxodisulfate and 164.6 g of distilled water, (3) a mixture of 72.0 g of water, 49.1 g of methacrylic acid and 166.9 g of methoxypolyethylene glycol methacrylate (M_{w}=1100) and (4) 46 g of a 40% strength by weight aqueous sodium hydrogensulfite solution were added continuously over 5 h. Following after-stirring for two hours at 100° C., the reaction mixture was cooled to room temperature and adjusted to a pH of 7.2 by adding 190 g of 50% strength by weight sodium hydroxide solution.

A slightly yellowish, clear solution of a copolymer with a solids content of 25.7% by weight and a K value of 27.2 (1%. strength by eight aqueous solution, 25° C.) was obtained.

### Example 2

In the reactor from example 1, a mixture of 221.6 g of distilled water and 1.1 g of phosphorus acid was heated to an internal temperature of 100° C. with the introduction of nitrogen and stirring. Then, in parallel, (1) a mixture of 38.6 g of acrylic acid and 231.0 g of distilled water, (2) a mixture of 29.6 g of toluene,, 27.7 g of methacrylic acid and 116.6 g of methoxypolyethylene glycol methacrylate (M_{w}=1100) and (3) 68.6 g of a 40% strength by weight aqueous sodium hydrogensulfite solution were added continuously over 5 h. In parallel to this, a mixture of 9.1 g of sodium peroxodisulfate and 82.3 g of distilled water was added over 5.25 h. In parallel to these feeds, a mixture of water and toluene was continuously distilled off, and the water was returned to the reaction (azeotropic removal of the toluene).

Following after-stirring for one hour at 100° C., the reaction mixture was cooled to room temperature and adjusted to a pH of 7.2 by adding 85 g of 50% strength by weight sodium hydroxide solution.

A clear polymer solution with a solids content of 28.8% by weight and a K value of 28.9 (1% strength by weight aqueous solution, 25° C.) was obtained.

B) Use of Copolymers Containing Alkylene Oxide Units in Dishwashing Detergents

To test their deposit-inhibiting action, the copolymers obtained were used together with a dishwashing detergent formulation having the following composition:
50% by weight sodium tripolyphosphate (Na₃P₃O₁₀.6 H₂O)
27% by weight sodium carbonate
3% by weight sodium disilicate (x Na₂O.y SiO₂; x/y=2.65; 80% strength)
6% by weight sodium percarbonate (Na₂CO₃.1.5 H₂O₂)
2% by weight tetraacetylenediamine (TAED)
2% by weight low-foam nonionic surfactant based on fatty alcohol alkoxylates
3% by weight sodium chloride
5% by weight sodium sulfate
2% by weight polyacrylic acid sodium salt (M_{w} 8 000)

The test was carried out under the following washing conditions without the addition of ballast soiling, with neither rinse aid nor regenerating salt being used:

Washing conditions:

| | |
|---|---|
| Dishwasher: | Miele G 686 SC |
| Wash programs: | 2 wash programs at 55° C. normal (without |
| | prewash) |
| Ware: | knives (WMF Tafelmesser Berlin, |
| | Monoblock) and barrel-shaped glass |
| | beakers (Matador, Ruhr Kristall) |
| Dishwashing detergent: | 21 g |
| Copolymer: | 4.2 g |
| Clear-rinse temperature: | 65° C. |
| Water hardness: | 25° German hardness |

The ware was evaluated 18 h after washing by visual assessment in a black-painted light box with halogen spotlight and pinhole diaphragm using a grading scale from 10 (very good) to 1 (very poor). The highest grade 10 corresponds here to surfaces free from deposits and drops, from grades <5, deposits and drops are visible in normal room lighting, and are therefore regarded as troublesome.

The test results obtained are listed in the table below.

TABLE

Evaluation (grade)

| Copolymer from Ex. | Knives | Glasses |
|---|---|---|
| 1 | 8.0 | 7.7 |
| 2 | 6.2 | 7.5 |
| — | 4.0 | 4.0 |

1. A detergent or a cleaner which comprises one or more copolymers comprising alkylene oxide units which comprise
(a) 50 to 93 mol % of acrylic acid and/or a water-soluble salt of acrylic acid,
(b) 5 to 30 mol % of methacrylic acid and/or a water-soluble salt of methacrylic acid
and
(c) 2 to 20 mol % of at least one nonionic monomer of formula I 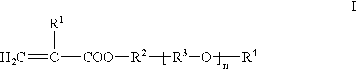
wherein:
R¹ is hydrogen or methyl;
R² is a chemical bond or unbranched or branched C₁-C₆-alkylene;
R³ are identical or different unbranched or branched C₂-C₄-alkylene radicals;
R⁴ is unbranched or branched C₁-C₆-alkyl;
n is 3 to 50,
in random or block copolymerized form.

2. The detergent or cleaner as claimed in claim 1, wherein said one or more copolymers comprise 65 to 85 mol % of component (a), 10 to 25 mol % of component (b) and 5 to 15 mol % of component (c) in copolymerized form.

3. The detergent or cleaner as claimed in claim 1, wherein said one or more copolymers comprise 65 to 75 mol % of component (a), 15 to 25 mol % of component (b) and 5 to 10 mol % of component (c) in copolymerized form.

4. The detergent or cleaner as claimed in claim 1, wherein said one or more copolymers comprise, as component (c), a nonionic monomer of the formula I wherein R¹ is methyl, R² is a chemical bond, R³ is C₂-C₃-alkylene, R⁴ is C₁-C₂-alkyl and n is 5 to 40, in copolymerized form.

5. The detergent or cleaner as claimed in claim 1, wherein said one or more copolymers comprise, as component (c), a nonionic monomer of the formula I wherein R¹ is methyl, R² is a chemical bond, R³ is ethylene, R⁴ is methyl and n is 10 to 30, in copolymerized form.

6. The detergent or cleaner as claimed in claim 1, wherein said one or more copolymers comprise —SO₃⁻Na⁺ and/or —SO₄⁻Na⁺ as end-groups.

7. (canceled)

8. The detergent or cleaner as claimed in claim 1 which comprises said one or more copolymers as deposit-inhibiting additive.

9. The detergent or cleaner as claimed in claim 8, wherein said detergent is a machine dishwashing detergent.
